(19) United States
(12) Patent Application Publication
(10) Pub. No.: US 2015/0216361 A1
(43) Pub. Date: Aug. 6, 2015

(54) DEVICE AND METHOD FOR MIXING DRINKS

(71) Applicant: Vim & Vigor Design Inc., New York, NY (US)

(72) Inventors: Aaron Tsui, Brooklyn, NY (US); Jon Eng, Brooklyn, NY (US)

(73) Assignee: VIM & VIGOR DESIGN INC., New York, NY (US)

(21) Appl. No.: 14/169,807

(22) Filed: Jan. 31, 2014

(51) Int. Cl. A47J 43/27

(52) U.S. Cl. CPC A47J 43/27

(57) ABSTRACT

The present invention is a set of compatible sized components designed to facilitate the easy and accurate creation of mixed drinks. The set includes a vessel, a shaker lid, and a muddle strainer tool. The muddle strainer tool has a ribbed bottom surface for muddling ingredients and is perforated to allow liquids to pass back and forth between the muddle strainer tool and the vessel. The lid may be equipped with a rubberized seal for use in preparing shaken beverages and may also functions as a coaster. The vessel or muddle strainer may include any of the following on the surface thereof a list of ingredients, recipe, instructions, and measurement lines for preparing a mixed beverage.

### FIELD OF THE INVENTION

The present invention relates to mixing containers, drinking vessels, measuring cups, and bar tools for preparation of mixed beverages.

### BACKGROUND OF THE INVENTION

Mixing containers and drinking vessels are known. They can be made of a variety of materials, including glass, metal, ceramic and plastic. Measuring cups are also known. They can also be made of a variety of materials, including glass, metal and plastic.

In the process of preparing mixed beverages, one requires many ingredients, vessels and tools to measure and combine the ingredients. Traditionally, vessels are void of any indicia for measurement of ingredients. They are also void of recipes and instructions on how to achieve a specific mixed beverage. The user has to refer to recipe books or instructions found online. The user also requires multiple tools such as muddlers, strainers, shakers, stirrers, zesters and peelers. To create just one cocktail for example, may require up to 2 vessels, a shaker, muddler, stirrer, jigger, and zester. In using so many tools and vessels, the user is left with a mess of dirty dishes to be washed prior to preparing the next mixed beverage or for later use.

### SUMMARY OF THE INVENTION

The present invention facilitates the preparation of mixed beverages while reducing the amount of vessels, recipes, and tools needed. The present invention is a set of bar tools comprised of three components: a container or drinking vessel, a muddle strainer tool, and a shaker lid. The container or vessel may be designed to create and accommodate one serving (drink) or multiple servings (drinks).

### DESCRIPTION OF THE DRAWINGS

FIG. 1 is a front view of the vessel with the shaker lid positioned on top.

FIG. 2 is a cross-sectional view of the vessel with the shaker lid positioned on top.

FIG. 3 is a top view of the shaker lid.

FIG. 4 is a bottom view of the vessel with the shaker lid attached.

FIG. 5 is a front view of the muddle strainer tool.

FIG. 6 is a cross-sectional view of the muddle strainer tool.

FIG. 7 is a top view of the muddle strainer tool.

FIG. 8 is a bottom view of the muddle strainer tool.

FIG. 9 is a top perspective view of the muddle strainer tool.

FIG. 10 is a top perspective view of the muddle strainer tool positioned inside of the drinking vessel.

FIG. 11 is a front view of the muddle strainer tool positioned inside of the drinking vessel.

FIG. 12 is a cross-sectional view of the muddle strainer tool positioned inside of the drinking vessel.

FIG. 13 is a bottom perspective view of the drinking vessel and shaker lid.

FIG. 14 is a top perspective view of the shaker lid positioned on top of the drinking vessel.

FIG. 15 is a top perspective view of the shaker lid positioned on the base of the drinking vessel.

FIG. 16 is a top perspective view of the sleeve.

FIG. 17 is a top perspective view of the sleeve on the vessel.

FIG. 18 is a front view of a stirrer.

FIG. 19 is a top perspective view of a stirrer placed within the vessel.

### DETAILED DESCRIPTION

The present invention is a set of compatible sized components designed to facilitate the easy and accurate creation of mixed drinks, while reducing the number of vessels and tools needed. The present invention is comprised of a vessel 1, a muddle strainer tool 2, and a shaker lid 3. The vessel 1 may be any size desired such as a cup or jigger glass, as is commonly known, or larger in size to accommodate more than one serving.

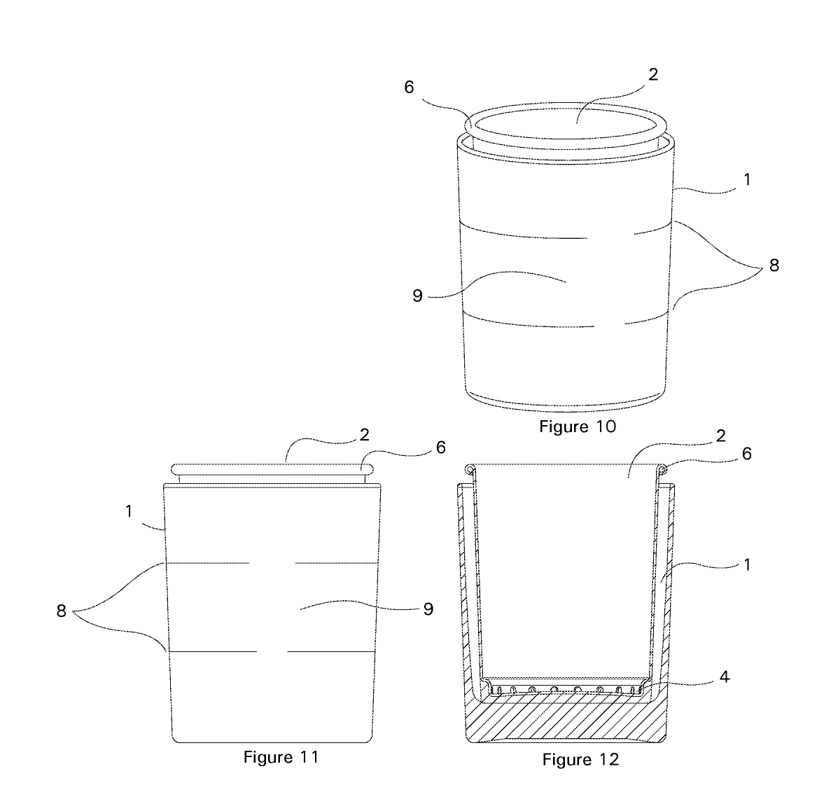

As depicted in FIGS. 10, 11, and 12, the muddle strainer tool 2, is sized to fit inside of the vessel 1. The base of the muddle strainer tool 2 has a ribbed bottom surface 4 capable of muddling ingredients. The base of the muddle strainer tool 2 also has perforations 5 to allow liquids to pass back and forth between the muddle strainer tool 2 and the vessel 1. The top rim 6 of the muddle strainer tool 2 is rounded over to provide a comfortable grip during use.

As depicted in FIGS. 14 and 15, the shaker lid 3 may be sized to fit securely around both the top and base of the vessel 1. This allows the shaker lid 3 to function as a lid for the vessel 1 or as a coaster. The shaker lid 3 may also be equipped with a rubberized seal 7. The rubberized seal 7 may take the form of a silicone lip that fits securely around the top or base of the vessel 1.

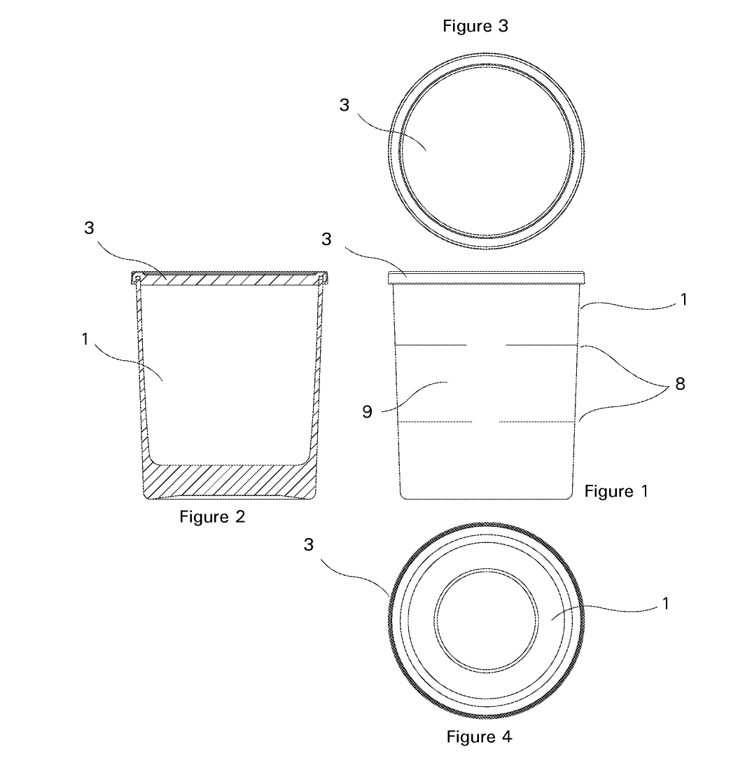

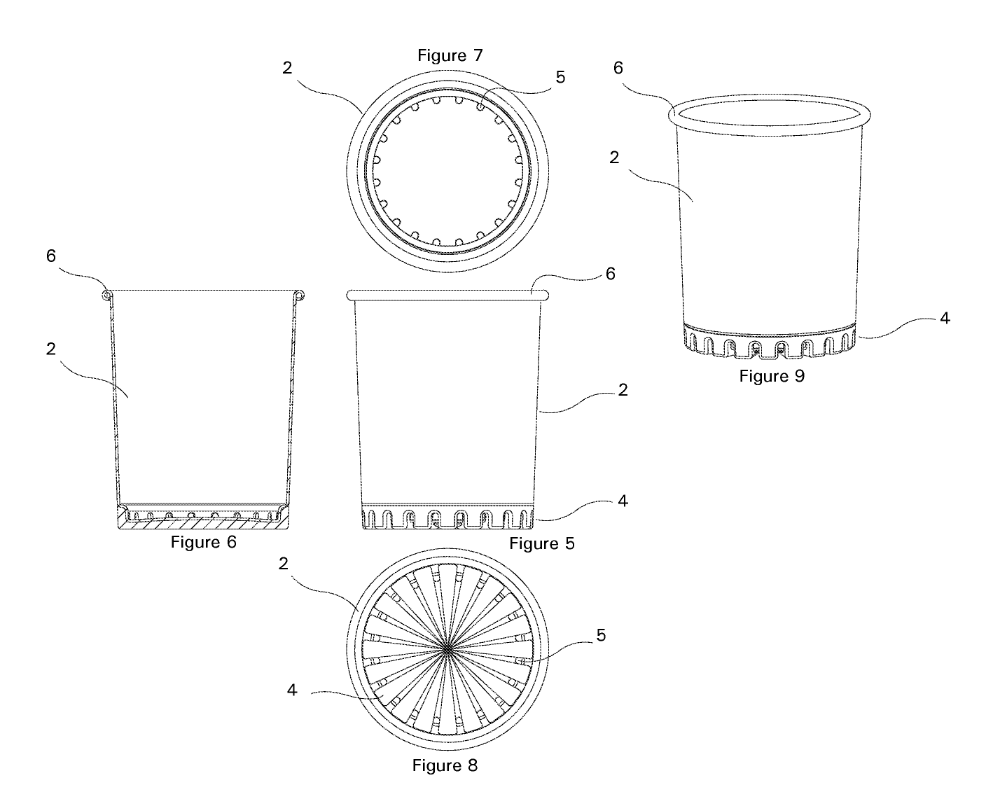

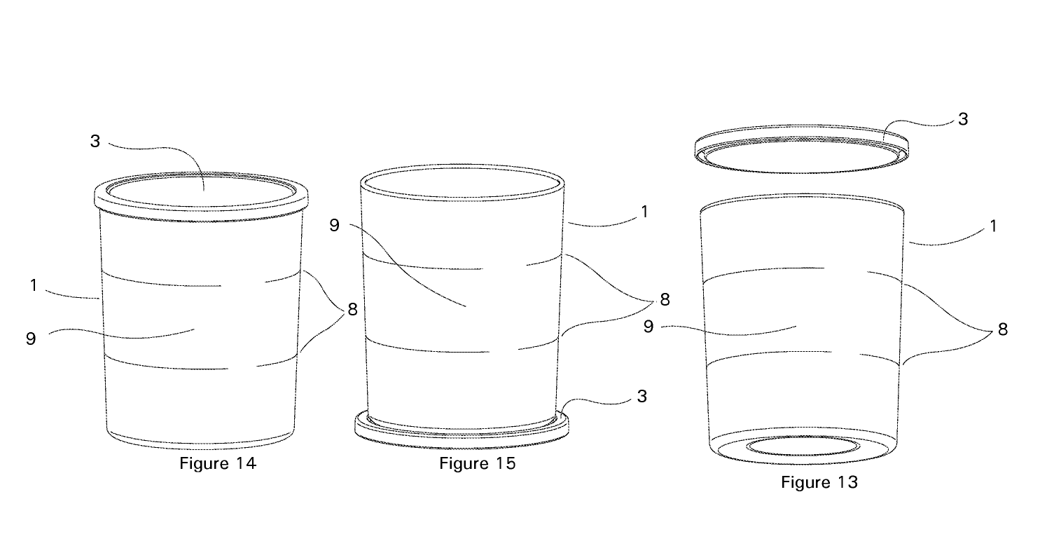

As depicted in FIGS. 1, 10, 11, and 13-15, the vessel 1 may also include on the surface thereof the ingredients for a particular recipe 9 and measurement lines 8 for that specific recipe which are labeled with the corresponding ingredient. For example in one embodiment, the vessel includes on the surface thereof the ingredients and recipe 9 for a drink commonly referred to as an “Absinthe Sazerac.” The measuring lines 8 would indicate the level of Rye Whiskey and ice and water that should be added. The recipe 9 would list the additional ingredients (traditionally a dash of absinthe, a sugar cube, 4-5 Peychaud Bitters, and lemon twist for garnish). The measurement lines 8 and recipe 9 can be modified accordingly for other mixed beverages.

In another embodiment, the measurement lines 8 may take the form of steps incorporated in the shape of the vessel 1 to indicate specific volumes and measurements of ingredients.

In another embodiment, the recipe 9 and measurement lines 8 for a specific beverage are included on the surface of the muddle strainer tool 2.

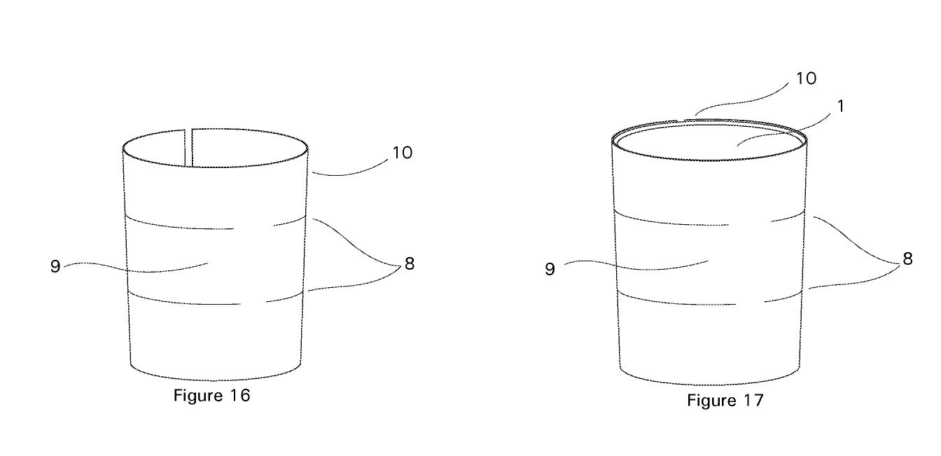

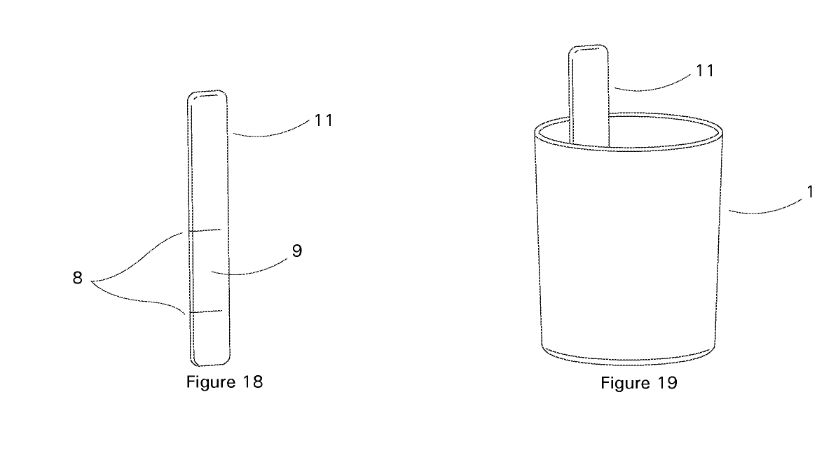

In another embodiment, as shown in FIGS. 16 and 17, the set includes a sleeve 10 sized specifically to fit securely around the perimeter of the intended vessel 1. On the surface of the sleeve 10 are the ingredients for a particular recipe 9 and measurement lines 8 for that specific beverage which are labeled with the corresponding ingredient. The sleeve 10 may be made of a material such that it is disposable or reusable and washable.

In another embodiment, as shown in FIGS. 18 and 19, the set includes a stirrer 11, which is labeled with the ingredients for a particular recipe 9 and measurement lines 8 for that specific beverage. In that way, the stirrer 11 acts as a measuring stick. The measurement lines 8 on the stirrer 11 are based upon the particular geometry of the accompanying vessel 1.

In one proposed method of use, the user places ingredients to be muddled in the bottom of the vessel 1 and then inserts the muddle strainer tool 2 into the vessel 1 and muddles the ingredients. The user then removes the muddle strainer tool 2 and adds the desired liquid ingredients to make the beverage. The shaker lid 3 may then be secured to the top of the vessel 1 to seal the vessel and allow for shaking. Alternatively, the shaker lid 3 may be secured to the bottom of the vessel 1 to function as a coaster. The beverage may then be imbibed directly from the vessel 1 or transferred to a separate container or vessel.

In a second proposed method of use, the user places the muddle strainer tool 2 into the vessel 1 and then fills the muddle strainer tool 2 with the desired ingredients to be mixed. The user then twists or otherwise manipulates the muddle strainer tool 2 to mix the ingredients. As the muddle strainer tool 2 is then removed from the vessel 1, the liquid ingredients pass through the perforations 5 and thereby remain in the vessel 1. The beverage may then be imbibed directly from the vessel 1 or transferred to a separate container or vessel.

In a third proposed method of use, the user places the muddle strainer tool 2 into the vessel 1 and then fills the muddle strainer tool 2 with the ingredients specified in the recipe 9 in accordance with the measuring lines 8 included on either the vessel 1 or the muddle strainer tool 2. The user then twists or otherwise manipulates the muddle strainer tool 2 to mix the ingredients. As the muddle strainer tool 2 is then removed from the vessel 1, the liquid ingredients pass through the perforations 5 and thereby remain in the vessel 1. The beverage may then be imbibed directly from the vessel 1 or transferred to a separate container or vessel.

In a fourth proposed method of use, the user refers to the recipe found on the surface of the vessel 1 and places ingredients to be muddle into the vessel 1. The user then inserts the muddle strainer tool 2 and muddles the ingredients. The user then removes the muddle strainer tool 2 and adds the ingredients specified on the recipe 8 in accordance with the measuring lines 9 included on the vessel 1. The shaker lid 3 may then be secured to the top of the vessel 1 to seal the vessel and allow for shaking. Alternatively, the shaker lid 3 may be secured to the bottom of the vessel 1 to function as a coaster. The beverage may then be imbibed directly from the vessel 1 or transferred to a separate container or vessel.

In a fifth proposed method of use, the user places ingredients to be muddled in the bottom of the vessel 1 and then inserts the muddle strainer tool 2 into the vessel 1 and muddles the ingredients. The user then removes the muddle strainer tool 2 and inserts the stirrer 11 into the vessel 1. The user then adds the liquid ingredients in accordance with the measurement lines on the stirrer 11. The stirrer 11 may then be used to stir the ingredients or removed from the vessel 1. The shaker lid 3 may then be secured to the top of the vessel 1 to seal the vessel and allow for shaking. Alternatively, the shaker lid 3 may be secured to the bottom of the vessel 1 to function as a coaster. The beverage may then be imbibed directly from the vessel 1 or transferred to a separate container or vessel.

In a sixth proposed method of use, the user inserts the vessel 1 into the sleeve 10. The user then places ingredients to be muddled in the bottom of the vessel 1 and inserts the muddle strainer tool 2 into the vessel 1 and muddles the ingredients. The user then removes the muddle strainer tool 2 and adds the liquid ingredients in accordance with the recipe 9 and measurement lines 8 on the sleeve 10. The vessel 1 may then be removed from the sleeve 10. The shaker lid 3 may then be secured to the top of the vessel 1 to seal the vessel and allow for shaking. Alternatively, the shaker lid 3 may be secured to the bottom of the vessel 1 to function as a coaster. The beverage may then be imbibed directly from the vessel 1 or transferred to a separate container or vessel.

In a seventh proposed method of use, the user the user places ingredients to be muddled in the bottom of the vessel 1 and then inserts the muddle strainer tool 2 into the vessel 1 and muddles the ingredients. The user then removes the muddle strainer tool 2. The user then adds the liquid ingredients in accordance with the steps incorporated in the shape of the vessel 1.

The above is a detailed description of particular embodiments of the invention. It is recognized that departures from the disclosed embodiments may be made within the scope of the invention and that obvious modifications will occur to a person skilled in the art. Those of skill in the art should, in light of the present disclosure, appreciate that many changes can be made in the specific embodiments which are disclosed herein and still obtain a like or similar result without departing from the spirit and scope of the invention. All of the embodiments disclosed and claimed herein can be made and executed without undue experimentation in light of the present disclosure.

We claim the following:

1. A set for mixing drinks comprising:
a vessel;
a muddle strainer tool designed to fit inside the vessel; and,
a shaker lid designed to be secured on top of the vessel.

2. The set according to claim 1 wherein a list of ingredients, a recipe, and corresponding measurement lines are labeled on at least one of the following: the vessel; the muddle strainer tool.

3. The set according to claim 2 wherein the muddle strainer tool includes a ribbed bottom surface capable of muddling ingredients, and perforations to allow the passage of liquids.

4. The set according to claim 3 wherein the shaker lid is equipped with a rubberized seal and is sized to be secured to both the top and base of the vessel.

5. The set according to claim 4 wherein the rubberized seal of the shaker lid includes a silicone lip that fits securely around the top or base of the vessel.

6. The set according to claim 1 further comprising a stirrer tool which is labeled with measurement lines corresponding to the ingredients for a particular recipe.

7. The set according to claim 6 wherein the muddle strainer tool includes a ribbed bottom surface capable of muddling ingredients, and perforations to allow the passage of liquids.

8. The set according to claim 7 wherein the shaker lid is equipped with a rubberized seal and is sized to be secured to both the top and base of the vessel.

9. The set according to claim 1 further comprising a sleeve sized to fit securely around the vessel, wherein the sleeve is labeled with a list of ingredients, a recipe, and corresponding measurement lines.

10. The set according to claim 9 wherein the muddle strainer tool includes a ribbed bottom surface capable of muddling ingredients, and perforations to allow the passage of liquids.

11. The set according to claim 10 wherein the shaker lid is equipped with a rubberized seal and is sized to be secured to both the top and base of the vessel.

12. A method for creating a mixed drink set comprising:
creating a vessel;
creating a muddle strainer tool designed to be placed inside the vessel;
creating a lid designed to securely fit a top and a bottom of the vessel;
indicating a list of ingredients, a recipe, and corresponding measurement lines labeled on at least one of the following: the vessel; the muddle strainer tool.

13. The method according to claim 12 wherein the muddle strainer tool includes a ribbed bottom surface capable of muddling ingredients, and perforations to allow the passage of liquids; and the shaker lid is equipped with a rubberized seal which is sized to be secured to both the top and base of the vessel.

14. A method for making a mixed drink comprising:
creating a vessel;
creating a muddle strainer tool designed to be placed inside the vessel;
creating a lid designed to securely fit a top and a bottom of the vessel;
indicating a list of ingredients, a recipe, and corresponding ingredient measurement lines labeled on at least one of the following: the vessel; the muddle strainer tool;
placing ingredients to be muddled in the bottom of the vessel;
inserting the muddle strainer tool into the vessel;
manipulating the muddle strainer tool to muddle the ingredients;
removing the muddle strainer tool;
adding the liquid ingredients;
securing the shaker lid to the top of the vessel;
shaking the vessel;
removing the shaker lid.

15. The set according to claim 14 wherein the muddle strainer tool includes a ribbed bottom surface capable of muddling ingredients, and perforations to allow the passage of liquids.

16. A method for making a mixed drink comprising:
creating a vessel;
creating a muddle strainer tool designed to be placed inside the vessel;
creating a lid designed to securely fit a top and a bottom of the vessel;
creating a sleeve design to fit securely on the vessel;
indicating a list of ingredients, a recipe, and corresponding ingredient measurement lines labeled on at least one of the following: the vessel; the muddle strainer tool;
placing ingredients to be muddled in the bottom of the vessel;
inserting the muddle strainer tool into the vessel;
manipulating the muddle strainer tool to muddle the ingredients;
removing the muddle strainer tool;
adding the liquid ingredients in accordance with the recipe and measuring lines on the sleeve;
securing the shaker lid to the vessel.
